(19) United States
(12) Patent Application Publication
(10) Pub. No.: US 2020/0327303 A1
(43) Pub. Date: Oct. 15, 2020

(54) Method for system control through fingerprint input

(71) Applicant: Kuan-Yu Tseng, New Taipei City (TW)

(72) Inventor: Kuan-Yu Tseng, New Taipei City (TW)

(21) Appl. No.: 16/915,461

(22) Filed: Jun. 29, 2020

(51) Int. Cl. G06K 9/00; G06K 9/46; G06F 3/0488; G06F 21/32

(52) U.S. Cl. CPC G06K 9/00026; G06K 9/4642; G06F 21/32; G06F 3/04883; G06K 9/00973

(57) ABSTRACT

A method for system control through fingerprint input includes using fingerprint input recognition, creating and storing the user's fingerprint recognition data, dividing the fingerprint images into a plurality of image blocks, and setting block control codes to execute the corresponding system executable programs in order to control or set various functional operations or data input of the system.

### BACKGROUND OF THE INVENTION

### 1. Field of the Invention

The invention relates to fingerprints and more particularly to a method for system control through fingerprint input.

### 2. Description of Related Art

Generally, most conventional electronic devices supporting touch input use built-in system software to provide a preset touch input interface for the user to input with his/her finger to control settings or to operate the system functions. As for fingerprint recognition, there is no other extended control applications except that the fingerprint of the whole surface of the front end of the user's finger is used to unlock the input operation interface of the electronic device.

However, touch screen resolutions of electronic device supporting touch input become increasingly higher and have reached 2K, 4K or even up to 8K in the near future. As a result, new electronic devices are capable of more accurate fingerprint recognition are desired.

### SUMMARY OF THE INVENTION

It is therefore one object of the invention to provide a method for system control through fingerprint input comprising using fingerprint input recognition, creating and storing the user's fingerprint recognition data, dividing the fingerprint images into a plurality of image blocks, and setting block control codes to execute the corresponding system executable programs in order to control or set various functional operations or data input of the system.

The above and other objects, features and advantages of the invention will become apparent from the following detailed description taken with the accompanying drawings.

### BRIEF DESCRIPTION OF THE DRAWINGS

FIG. 1 is a schematic view of image blocks of a first fingerprint image of the invention;

FIG. 2 is a schematic view of image blocks of a second fingerprint image of the invention; and

FIG. 3 is a schematic view of image blocks of a third fingerprint image of the invention.

### DETAILED DESCRIPTION OF THE INVENTION

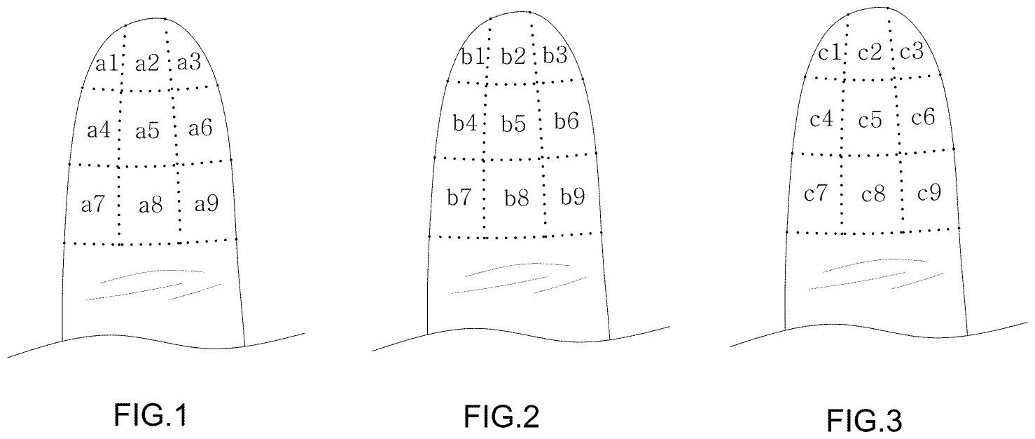

Referring to FIGS. 1 to 3, a method for system control through fingerprint input in accordance with a first preferred embodiment of the invention is illustrated. The method is applied in electronic devices supporting touch input. The method comprises: fingerprint input recognition of the fingerprints of three fingers of the user through the touch screen of the electronic device supporting touch input, and creation and storage of the user's fingerprint recognition data; wherein, the fingerprint recognition data comprises: first fingerprint image, second fingerprint image and third fingerprint image.

The built-in system software of the electronic device supporting touch input can divide each fingerprint image from the fingerprint recognition data into 9 image blocks and set a corresponding block control code for each of the image blocks; wherein, in an order from top to bottom and from left to right, these image blocks are respectively defined as first image block, second image block, third image block, fourth image block, fifth image block, sixth image block, seventh image block, eighth image block, and ninth image block.

The block control code of the first image block a1 of the first fingerprint image is set to A11, the block control code of the second image block a2 is set to A12, the block control code of the third image block a3 is set to A13, the block control code of the fourth image block a4 is set to A21, the block control code of the fifth image block a5 is set to A22, the block control code of the sixth image block a6 is set to A23, the block control code of the seventh image block a7 is set to A31, the block control code of the eighth image block a8 is set to A32, and the block control code of the ninth image block a9 is set to A33. The block control code of the first image block b1 of the second fingerprint image is set to B11, the block control code of the second image block b2 is set to B12, the block control code of the third image block b3 is set to B13, the block control code of the fourth image block b4 is set to B21, the block control code of the fifth image block b5 is set to B22, the block control code of the sixth image block b6 is set to B23, the block control code of the seventh image block b7 is set to B31, the block control code of the eighth image block b8 is set to B32, and the block control code of the ninth image block b9 is set to B33. The block control code of the first image block c1 of the third fingerprint image is set to C11, the block control code of the second image block c2 is set to C12, the block control code of the third image block c3 is set to C13, the block control code of the fourth image block c4 is set to C21, the block control code of the fifth image block c5 is set to C22, the block control code of the sixth image block c6 is set to C23, the block control code of the seventh image block c7 is set to C31, the block control code of the eighth image block c8 is set to C32, and the block control code of the ninth image block c9 is set to C33.

Through the input settings of the electronic device supporting touch input, the user can carry out the fingerprint image digital control setup program. Based on the user's input settings, the built-in system software of the electronic device supporting touch input can respectively set the block control codes of those image blocks of the first fingerprint image, the block control codes of those image blocks of the second fingerprint image and the block control codes of those image blocks of the third fingerprint image to the command codes to execute the built-in digital executable programs of the system software.

Through the fingerprint image digital control setup program, the user can set the block control code A12 to the command code to execute the digital executable program to “Enter 0”, set the combination of the block control codes A21 and A31 to the command code to execute the digital executable program to “Enter 1”, set the combination of the block control codes A22 and A32 to the command code to execute the digital executable program to “Enter 2”, set the combination of the block control codes A23 and A33 to the command code to execute the digital executable program to “Enter 3”, set the block control code B12 to the command code to execute the digital executable program to “Enter 4”, set the combination of the block control codes B21 and B31 to the command code to execute the digital executable program to “Enter 5”, set the combination of the block control codes B22 and B32 to the command code to execute the digital executable program to “Enter 6”, set the combination of the block control codes B23 and B33 to the command code to execute the digital executable program to “Enter 7”, set the block control code C12 to the command code to execute the digital executable program to “Enter 8”, set the combination of the block control codes C21 and C31 to the command code to execute the digital executable program to “Enter 9”, set the combination of the block control codes C22 and C32 to the command code to execute the digital executable program to “Enter Symbol *”, set the combination of the block control codes C23 and C33 to the command code to execute the digital executable program to “Enter Symbol #”.

The user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input. The system software will then obtain the block control code of the image block or the block control codes of those image blocks of the effective input to execute the corresponding digital executable program to enter a number, a symbol, or a character.

When the user conducts fingerprint input and, upon comparison and analysis, the system software confirms that the block control code corresponding to the image block of the fingerprint image of the effective input is only A12, the system software will execute the digital executable program to “Enter 0” and meanwhile display Number 0 on the touch screen of the electronic device supporting touch input. It works totally the same as if the user touches Number 0 on the electronic numeric keyboard displayed on the touch screen of the electronic device supporting touch input to “Enter 0”. When the user conducts fingerprint input and, upon comparison and analysis, the system software confirms that the block control codes corresponding to those image blocks of the fingerprint image of the effective input are only the combination of A21 and A31, the system software will execute the digital executable program to “Enter 1” and meanwhile display Number 1 on the touch screen of the electronic device supporting touch input. It works totally the same as if the user touches Number 1 on the electronic numeric keyboard displayed on the touch screen of the electronic device supporting touch input to “Enter 1”. When the user conducts fingerprint input and, upon comparison and analysis, the system software confirms that the block control codes corresponding to those image blocks of the fingerprint image of the effective input are only the combination of A22 and A32, the system software will execute the digital executable program to “Enter 2” and meanwhile display Number 2 on the touch screen of the electronic device supporting touch input. It works totally the same as if the user touches Number 2 on the electronic numeric keyboard displayed on the touch screen of the electronic device supporting touch input to “Enter 2”. When the user conducts fingerprint input and, upon comparison and analysis, the system software confirms that the block control codes corresponding to those image blocks of the fingerprint image of the effective input are only the combination of A23 and A33, the system software will execute the digital executable program to “Enter 3” and meanwhile display Number 3 on the touch screen of the electronic device supporting touch input. It works totally the same as if the user touches Number 3 on the electronic numeric keyboard displayed on the touch screen of the electronic device supporting touch input to “Enter 3”.

When the user conducts fingerprint input and, upon comparison and analysis, the system software confirms that the block control code corresponding to the image block of the fingerprint image of the effective input is only B12, the system software will execute the digital executable program to “Enter 4” and meanwhile display Number 4 on the touch screen of the electronic device supporting touch input. It works totally the same as if the user touches Number 4 on the electronic numeric keyboard displayed on the touch screen of the electronic device supporting touch input to “Enter 4”. When the user conducts fingerprint input and, upon comparison and analysis, the system software confirms that the block control codes corresponding to those image blocks of the fingerprint image of the effective input are only the combination of B21 and B31, the system software will execute the digital executable program to “Enter 5” and meanwhile display Number 5 on the touch screen of the electronic device supporting touch input. It works totally the same as if the user touches Number 5 on the electronic numeric keyboard displayed on the touch screen of the electronic device supporting touch input to “Enter 5”. When the user conducts fingerprint input and, upon comparison and analysis, the system software confirms that the block control codes corresponding to those image blocks of the fingerprint image of the effective input are only the combination of B22 and B32, the system software will execute the digital executable program to “Enter 6” and meanwhile display Number 6 on the touch screen of the electronic device supporting touch input. It works totally the same as if the user touches Number 6 on the electronic numeric keyboard displayed on the touch screen of the electronic device supporting touch input to “Enter 6”. When the user conducts fingerprint input and, upon comparison and analysis, the system software confirms that the block control codes corresponding to those image blocks of the fingerprint image of the effective input are only the combination of B23 and B33, the system software will execute the digital executable program to “Enter 7” and meanwhile display Number 7 on the touch screen of the electronic device supporting touch input. It works totally the same as if the user touches Number 7 on the electronic numeric keyboard displayed on the touch screen of the electronic device supporting touch input to “Enter 7”.

When the user conducts fingerprint input and, upon comparison and analysis, the system software confirms that the block control code corresponding to the image block of the fingerprint image of the effective input is only C12, the system software will execute the digital executable program to “Enter 8” and meanwhile display Number 8 on the touch screen of the electronic device supporting touch input. It works totally the same as if the user touches Number 8 on the electronic numeric keyboard displayed on the touch screen of the electronic device supporting touch input to “Enter 8”. When the user conducts fingerprint input and, upon comparison and analysis, the system software confirms that the block control codes corresponding to those image blocks of the fingerprint image of the effective input are only the combination of C21 and C31, the system software will execute the digital executable program to “Enter 9” and meanwhile display Number 9 on the touch screen of the electronic device supporting touch input. It works totally the same as if the user touches Number 9 on the electronic numeric keyboard displayed on the touch screen of the electronic device supporting touch input to “Enter 9”. When the user conducts fingerprint input and, upon comparison and analysis, the system software confirms that the block control codes corresponding to those image blocks of the fingerprint image of the effective input are only the combination of C22 and C32, the system software will execute the digital executable program to “Enter Symbol *” and meanwhile display Symbol * on the touch screen of the electronic device supporting touch input. It works totally the same as if the user touches Symbol * on the electronic numeric keyboard displayed on the touch screen of the electronic device supporting touch input to “Enter Symbol *”.

When the user conducts fingerprint input and, upon comparison and analysis, the system software confirms that the block control codes corresponding to those image blocks of the fingerprint image of the effective input are only the combination of C23 and C33, the system software will execute the digital executable program to “Enter Symbol #” and meanwhile display Symbol # on the touch screen of the electronic device supporting touch input. It works totally the same as if the user touches Symbol # on the electronic numeric keyboard displayed on the touch screen of the electronic device supporting touch input to “Enter Symbol #”.

Referring to FIGS. 1 to 2 again, a method for system control through fingerprint input in accordance with a second preferred embodiment of the invention is illustrated. The method comprises: touch control setup program by the user through input settings of the electronic device supporting touch input. The built-in system software of the electronic device supporting touch input can, according to the input settings of the user, set the block control codes of those image blocks of the first fingerprint image and the block control codes of those image blocks of the second fingerprint image respectively to the command codes to execute the touch control executable programs in the system software.

Through the fingerprint image touch control setup program, the user can set the block control code A12 to the command code to execute the touch control executable program to “Swipe Up”, set the block control codes of the combination of A21 and A31 to the command code to execute the touch control executable program to “Swipe Left”, set the block control code A32 to the command code to execute the touch control executable program to “Swipe Down”, set the block control codes of the combination of A23 and A33 to the command code to execute the touch control executable program to “Swipe Right”, set the block control code B12 to the command code to execute the touch control executable program to “Move Cursor Up”, set the block control codes of the combination of B21 and B31 to the command codes to execute the touch control executable program to “Move Cursor Left”, set the block control code B32 to the command code to execute the touch control executable program to “Move Cursor Down”, and set the block control codes of the combination of B23 and B33 to the command codes to execute the touch control executable program to “Move Cursor Right”.

The user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input. The system software will then obtain the block control code of the image block or the block control codes of those image blocks of the effective input to execute the corresponding touch control executable program to substitute for the gesture input where the user swipes on the screen or control the cursor position.

When the user conducts fingerprint input and, upon comparison and analysis, the system software confirms that the block control code corresponding to the image block of the fingerprint image of the effective input is only A12, the system software will execute the touch control executable program to “Swipe Up”. It works totally the same as hand gesture input where the user touches and Swipes Up on the touch screen of the electronic device supporting touch input. When the user conducts fingerprint input and, upon comparison and analysis, the system software confirms that the block control codes corresponding to those image blocks of the fingerprint image of the effective input are only the combination of A21 and A31, the system software will execute the touch control executable program to “Swipe Left”. It works totally the same as hand gesture input where the user touches and Swipes Left on the touch screen of the electronic device supporting touch input. When the user conducts fingerprint input and, upon comparison and analysis, the system software confirms that the block control code corresponding to the image block of the fingerprint image of the effective input is only A32, the system software will execute the touch control executable program to “Swipe Down”. It works totally the same as hand gesture input where the user touches and Swipes Down on the touch screen of the electronic device supporting touch input. When the user conducts fingerprint input and, upon comparison and analysis, the system software confirms that the block control codes corresponding to those image blocks of the fingerprint image of the effective input are only the combination of A23 and A33, the system software will execute the touch control executable program to “Swipe Right”. It works totally the same as hand gesture input where the user touches and Swipes Right on the touch screen of the electronic device supporting touch input.

When the user conducts fingerprint input and, upon comparison and analysis, the system software confirms that the block control code corresponding to the image block of the fingerprint image of the effective input is only B12, the system software will execute the touch control executable program to “Move Cursor Up”. It works totally the same as if the user touches the touch screen of the electronic device supporting touch input to Move Cursor Up and position the cursor. When the user conducts fingerprint input and, upon comparison and analysis, the system software confirms that the block control codes corresponding to those image blocks of the fingerprint image of the effective input are only the combination of B21 and B31, the system software will execute the touch control executable program to “Move Cursor Left”. It works totally the same as if the user touches the touch screen of the electronic device supporting touch input to Move Cursor Left and position the cursor. When the user conducts fingerprint input and, upon comparison and analysis, the system software confirms that the block control code corresponding to the image block of the fingerprint image of the effective input is only B32, the system software will execute the touch control executable program to “Move Cursor Down”. It works totally the same as if the user touches the touch screen of the electronic device supporting touch input to Move Cursor Down and position the cursor. When the user conducts fingerprint input and, upon comparison and analysis, the system software confirms that the block control codes corresponding to those image blocks of the fingerprint image of the effective input are only the combination of B23 and B33, the system software will execute the touch control executable program to “Move Cursor Right”. It works totally the same as if the user touches the touch screen of the electronic device supporting touch input to Move Cursor Right and position the cursor.

Referring to FIGS. 1 to 2 again, a method for system control through fingerprint input in accordance with a third preferred embodiment of the invention is illustrated. The method comprises: fingerprint image system control settings by the user through input settings of the electronic device supporting touch input. The built-in system software of the electronic device supporting touch input can, according to the input settings of the user, set the block control codes of those image blocks of the first fingerprint image and the block control codes of those image blocks of the second fingerprint image, respectively to the command codes to execute the system executable programs in the system software.

Through the fingerprint image system control setup program, the user can set the block control code A12 to the command code to execute the system executable program to “Increase the Media Volume”, set the block control code A32 to the command code to execute the system executable program to “Decrease the Media Volume”, set the block control codes of the combination of A23 and A33 to the command codes to execute the system executable program to “Increase the Screen Brightness”, set the block control codes of the combination of A21 and A31 to the command codes to execute the system executable program to “Decrease the Screen Brightness”, set the block control code B12 to the command code to execute the system executable program to “Enable the Camera Mode”, set the block control code B32 to the command code to execute the system executable program to “Enable the Dialing Mode”, set the block control codes of the combination of B23 and B33 to the command codes to execute the system executable program to “Enable the WIFI Mode”, and set the block control codes of the combination of B21 and B31 to the command codes to execute the system executable program to “Turn on the LED Light”.

The user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input. The system software will then obtain the block control code of the image block or the block control codes of those image blocks of the effective input to execute the corresponding system executable program to adjust the media volume or screen brightness, or to start, shut down, control or set the system functional operations of the electronic device supporting touch input.

When the user conducts fingerprint input and, upon comparison and analysis, the system software confirms that the block control code corresponding to the image block of the fingerprint image of the effective input is only A12, the system software will execute the system executable program to “Increase the Media Volume”. It works totally the same as if the user touches the touch screen of the electronic device supporting touch input to increase the media volume. When the user conducts fingerprint input and, upon comparison and analysis, the system software confirms that the block control code corresponding to the image block of the fingerprint image of the effective input is only A32, the system software will execute the system executable program to “Decrease the Media Volume”. It works totally the same as if the user touches the touch screen of the electronic device supporting touch input to decrease the media volume. When the user conducts fingerprint input and, upon comparison and analysis, the system software confirms that the block control codes corresponding to those image blocks of the fingerprint image of the effective input are only the combination of A23 and A33, the system software will execute the system executable program to “Increase the Screen Brightness”. It works totally the same as if the user touches the touch screen of the electronic device supporting touch input to increase the screen brightness. When the user conducts fingerprint input and, upon comparison and analysis, the system software confirms that the block control codes corresponding to those image blocks of the fingerprint image of the effective input are only the combination of A21 and A31, the system software will execute the system executable program to “Decrease the Screen Brightness”. It works totally the same as if the user touches the touch screen of the electronic device supporting touch input to decrease the screen brightness.

When the user conducts fingerprint input and, upon comparison and analysis, the system software confirms that the block control code corresponding to the image block of the fingerprint image of the effective input is only B12, the system software will execute the system executable program to “Enable the Camera Mode” and meanwhile display the control interface of Camera Mode on the touch screen of the electronic device supporting touch input. It works totally the same as if the user touches the Camera icon displayed on the touch screen of the electronic device supporting touch input to “Enable the Camera Mode”. When the user conducts fingerprint input and, upon comparison and analysis, the system software confirms that the block control code corresponding to the image block of the fingerprint image of the effective input is only B32, the system software will execute the system executable program to “Enable the Dialing Mode” and meanwhile display the control interface of Dialing Mode on the touch screen of the electronic device supporting touch input. It works totally the same as if the user touches the Dialing icon displayed on the touch screen of the electronic device supporting touch input to “Enable the Dialing Mode”. When the user conducts fingerprint input and, upon comparison and analysis, the system software confirms that the block control codes corresponding to those image blocks of the fingerprint image of the effective input are only the combination of B23 and B33, the system software will execute the system executable program to “Enable the WIFI Mode” and meanwhile display the control interface of WIFI Mode on the touch screen of the electronic device supporting touch input. It works totally the same as if the user touches the WIFI icon displayed on the touch screen of the electronic device supporting touch input to “Enable the WIFI Mode”.

When the user conducts fingerprint input and, upon comparison and analysis, the system software confirms that the block control codes corresponding to those image blocks of the fingerprint image of the effective input are only the combination of B21 and B31, the system software will execute the system executable program to “Turn on the LED Light” and meanwhile display the control interface of LED Illumination on the touch screen of the electronic device supporting touch input. It works totally the same as if the user touches the LED icon displayed on the touch screen of the electronic device supporting touch input to “Turn on the LED Light”.

Referring to FIGS. 1 to 3 again, a method for system control through fingerprint input in accordance with a fourth preferred embodiment of the invention is illustrated.

The method comprises: fingerprint image game control settings by the user through input settings of the electronic device supporting touch input. The built-in system software of the electronic device supporting touch input can, according to the input settings of the user, set the block control codes of those image blocks of the first fingerprint image, the block control codes of those image blocks of the second fingerprint image, and the block control codes of those image blocks of the third fingerprint image, respectively to the command codes to execute the game software executable programs in the system software.

Through the fingerprint image game control setup program, the user can set the block control code A12 to the command code to execute the game software executable program to “Move Forward”, set the block control codes of the combination of A21 and A31 to the command codes to execute the game software executable program to “Move Left”, set the block control code A32 to the command code to execute the game software executable program to “Move Backward”, set the block control codes of the combination of A23 and A33 to the command codes to execute the game software executable program to “Move Right”, set the block control code B12 to the command code to execute the game software executable program for “Attack Action”, set the block control codes of the combination of B21 and B31 to the command codes to execute the game software executable program for “Throwing Action”, set the block control code B32 to the command code to execute the game software executable program for “Jumping Action”, set the block control codes of the combination of B23 and B33 to the command codes to execute the game software executable program for “Defensive Action”, set the block control codes of the combination of C11 and C12 to the command codes to execute the game software executable program to “Open the Menu”, set the block control codes of the combination of C12 and C13 to the command codes to execute the game software executable program to “Turn off the Menu”, set the block control codes of the combination of C21 and C31 to the command codes to execute the game software executable program to “Select Left”, set the block control codes of the combination of C22 and C23 to the command codes to execute the game software executable program to “Select Right”, and set the block control code C32 to the command code to execute the game software executable program to “Confirm”.

The user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input. The system software will then obtain the block control code of the image block or the block control codes of those image blocks of the effective input to execute the corresponding game software executable program for motion control of the character or hero in the game screen or to open the menu for selection, setting or control.

When the user conducts fingerprint input and, upon comparison and analysis, the system software confirms that the block control code corresponding to the image block of the fingerprint image of the effective input is only A12, the system software will execute the game software executable program to “Move Forward” so that the character or hero in the game screen of the touch screen of the electronic device supporting touch input will Move Forward. When the user conducts fingerprint input and, upon comparison and analysis, the system software confirms that the block control code corresponding to the image block of the fingerprint image of the effective input are only the combination of A21 and A31, the system software will execute the game software executable program to “Move Left”, so that the character or hero in the game screen of the touch screen of the electronic device supporting touch input will Move Left.

When the user conducts fingerprint input and, upon comparison and analysis, the system software confirms that the block control code corresponding to the image block of the fingerprint image of the effective input is only A32, the system software will execute the game software executable program to “Move Backward”, so that the character or hero in the game screen of the touch screen of the electronic device supporting touch input will Move Backward. When the user conducts fingerprint input and, upon comparison and analysis, the system software confirms that the block control code corresponding to the image block of the fingerprint image of the effective input are only the combination of A23 and A33, the system software will execute the game software executable program to “Move Right”, so that the character or hero in the game screen of the touch screen of the electronic device supporting touch input will Move Right.

When the user conducts fingerprint input and, upon comparison and analysis, the system software confirms that the block control code corresponding to the image block of the fingerprint image of the effective input is only B12, the system software will execute the game software executable program for “Attack Action”, so that the character or hero in the game screen of the touch screen of the electronic device supporting touch input will have the Attack Action. When the user conducts fingerprint input and, upon comparison and analysis, the system software confirms that the block control code corresponding to the image block of the fingerprint image of the effective input are only the combination of B21 and B31, the system software will execute the game software executable program for “Throwing Action”, so that the character or hero in the game screen of the touch screen of the electronic device supporting touch input will have the Throwing Action. When the user conducts fingerprint input and, upon comparison and analysis, the system software confirms that the block control code corresponding to the image block of the fingerprint image of the effective input is only B32, the system software will execute game software executable program for “Jumping Action”, so that the character or hero in the game screen of the touch screen of the electronic device supporting touch input will have the Jumping Action. When the user conducts fingerprint input and, upon comparison and analysis, the system software confirms that the block control code corresponding to the image block of the fingerprint image of the effective input are only the combination of B23 and B33, the system software will execute the game software executable program for “Defensive Action”, so that the character or hero in the game screen of the touch screen of the electronic device supporting touch input will have the Defensive Action.

When the user conducts fingerprint input and, upon comparison and analysis, the system software confirms that the block control code corresponding to the image block of the fingerprint image of the effective input are only the combination of C11 and C12, the system software will execute the game software executable program to “Open the Menu”, so that the touch screen of the electronic device supporting touch input will display the game function menu screen. When the user conducts fingerprint input and, upon comparison and analysis, the system software confirms that the block control code corresponding to the image block of the fingerprint image of the effective input are only the combination of C12 and C13, the system software will execute the game software executable program to “Turn off the Menu”, so that the game function menu screen on the touch screen of the electronic device supporting touch input will be closed. When the user conducts fingerprint input and, upon comparison and analysis, the system software confirms that the block control code corresponding to the image block of the fingerprint image of the effective input are only the combination of C21 and C31, the system software will execute the game software executable program to “Select Left”, so that the selection cursor on the game function menu screen on the touch screen of the electronic device supporting touch input will Move Left. When the user conducts fingerprint input and, upon comparison and analysis, the system software confirms that the block control code corresponding to the image block of the fingerprint image of the effective input are only the combination of C23 and C33, the system software will execute the game software executable program to “Select Right”, so that the selection cursor on the game function menu screen on the touch screen of the electronic device supporting touch input will Move Right. When the user conducts fingerprint input and, upon comparison and analysis, the system software confirms that the block control code corresponding to the image block of the fingerprint image of the effective input is only C32, the system software will execute the game software executable program to “Confirm”, so that the selection cursor on the game function menu screen on the touch screen of the electronic device supporting touch input will Confirm the selection.

Referring to FIG. 1 again, a method for system control through fingerprint input in accordance with a fifth preferred embodiment of the invention is illustrated. The method comprises: fingerprint image software control settings by the user through the input settings of the electronic device supporting touch input. The built-in system software of the electronic device supporting touch input can, according to the input settings of the user, set the block control codes of those image blocks of the first fingerprint image respectively to the command codes to execute the application software executable program installed in the system software.

Through the fingerprint image software control setup program, the user can set the block control code A12 to the command code to execute the application software executable program to “Open the Browser”, set the block control code A32 to the command code to execute the application software executable program to “Open the Email”, set the block control codes of the combination of A23 and A33 to the command codes to execute the application software executable program to “Open LINE”, and set the block control codes of the combination of A21 and A31 to the command codes to execute the application software executable program to “Open Facebook”.

The user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input. The system software will then obtain the block control code of the image block or the block control codes of those image blocks of the effective input to execute the corresponding application software executable program for selection, setting or control of the software functions.

When the user conducts fingerprint input and, upon comparison and analysis, the system software confirms that the block control code corresponding to the image block of the fingerprint image of the effective input is only A12, the system software will execute the application software executable program to “Open the Browser” and meanwhile display the control interface of Web Browser program on the touch screen of the electronic device supporting touch input. It works totally the same as if the user touches the Web Browser program icon displayed on the touch screen of the electronic device supporting touch input to “Open the Browser”. When the user conducts fingerprint input and, upon comparison and analysis, the system software confirms that the block control code corresponding to the image block of the fingerprint image of the effective input is only A32, the system software will execute the application software executable program to “Open the Email” and meanwhile display the control interface of the Email program on the touch screen of the electronic device supporting touch input. It works totally the same as if the user touches the Email program icon displayed on the touch screen of the electronic device supporting touch input to “Open the Email”. When the user conducts fingerprint input and, upon comparison and analysis, the system software confirms that the block control codes corresponding to those image blocks of the fingerprint image of the effective input are only the combination of A23 and A33, the system software will execute the application software executable program to “Open LINE” and meanwhile display the control interface of the LINE program on the touch screen of the electronic device supporting touch input. It works totally the same as if the user touches the LINE program icon displayed on the touch screen of the electronic device supporting touch input to “Open LINE”. When the user conducts fingerprint input and, upon comparison and analysis, the system software confirms that the block control codes corresponding to those image blocks of the fingerprint image of the effective input are only the combination of A21 and A31, the system software will execute the application software executable program to “Open Facebook” and meanwhile display the control interface of the FACEBOOK program on the touch screen of the electronic device supporting touch input. It works totally the same as if the user touches the FACEBOOK program icon displayed on the touch screen of the electronic device supporting touch input to “Open Facebook”.

Referring to FIGS. 1 to 3 again, a method for system control through fingerprint input in accordance with a sixth preferred embodiment of the invention is illustrated. The method comprises: fingerprint image sequence control setup program by the user through the input settings of the electronic device supporting touch input. The built-in system software of the electronic device supporting touch input can, according to the input settings of the user, specify the input orders of specific permutations and combinations of the block control codes of those image blocks of the first fingerprint image, the block control codes of those image blocks of the second fingerprint image, and the block control codes of those image blocks of the third fingerprint image as input sequences of the image block control codes, and set the input sequences of the image block control codes to the command codes to execute the built-in digital executable programs, the command codes to execute the built-in touch control executable programs, or the command codes to execute the built-in system executable programs in the system software, or the command codes to execute the game software executable programs or the command codes to execute the application software executable programs installed in the system software.

Through the fingerprint image sequence control setup program, the user can specify the input order from the block control code A22 to the block control code A12 and to the block control code C22 as an image block control code input sequence, and set it to the command code to execute the system executable program to “Enable the Camera Mode”, specify the input order from the block control code A22 to the block control code A23 and to the block control code C22 as an image block control code input sequence and set it to the command code to execute the system executable program to “Enable the Dialing Mode”, specify the input order from the block control code A22 to the block control code A32 and to the block control code C22 as an image block control code input sequence and set it to the command code to execute the system executable program to “Enable the WIFI Mode”, specify the input order from the block control code A22 to the block control code A21 and to the block control code C22 as an image block control code input sequence and set it to the command codes to execute the system executable program to “Turn on the LED Light”, specify the input order from the block control code B22 to the block control code B12 and to the block control code C22 as an image block control code input sequence and set it to the command code to execute the application software executable program to “Open the Browser”, specify the input order from the block control code B22 to the block control code B23 and to the block control code C22 as an image block control code input sequence and set it to the command code to execute the application software executable program to “Open the Email”, specify the input order from the block control code B22 to the block control code B32 and to the block control code C22 as an image block control code input sequence and set it to the command code to execute the application software executable program to “Open LINE”, and specify the input order from the block control code B22 to the block control code B21 and to the block control code C22 as an image block control code input sequence and set it to the command code to execute the application software executable program to “Open Facebook”.

When the user conducts fingerprint input and, upon comparison and analysis, the system software confirms that the image block control code input sequence corresponding to the block control codes of those image blocks of the fingerprint images of the effective input is in the order from the block control code A22 to the block control code A12 and to the block control code C22, the system software will execute the system executable program to “Enable the Camera Mode” and meanwhile display the control interface of Camera Mode on the touch screen of the electronic device supporting touch input. It works totally the same as if the user touches the Camera icon displayed on the touch screen of the electronic device supporting touch input to “Enable the Camera Mode”. When the user conducts fingerprint input and, upon comparison and analysis, the system software confirms that the image block control code input sequence corresponding to the block control codes of those image blocks of the fingerprint images of the effective input is in the order from the block control code A22 to the block control code A23 and to the block control code C22, the system software will execute the system executable program to “Enable the Dialing Mode” and meanwhile display the control interface of Dialing Mode on the touch screen of the electronic device supporting touch input. It works totally the same as if the user touches the Dialing icon displayed on the touch screen of the electronic device supporting touch input to “Enable the Dialing Mode”. When the user conducts fingerprint input and, upon comparison and analysis, the system software confirms that the image block control code input sequence corresponding to the block control codes of those image blocks of the fingerprint images of the effective input is in the order from the block control code A22 to the block control code A32 and to the block control code C22, the system software will execute the system executable program to “Enable the WIFI Mode” and meanwhile display the control interface of WIFI Mode on the touch screen of the electronic device supporting touch input. It works totally the same as if the user touches the WIFI icon displayed on the touch screen of the electronic device supporting touch input to “Enable the WIFI Mode”. When the user conducts fingerprint input and, upon comparison and analysis, the system software confirms that the image block control code input sequence corresponding to the block control codes of those image blocks of the fingerprint images of the effective input is in the order from the block control code A22 to the block control code A21 and to the block control code C22, the system software will execute the system executable program to “Turn on the LED Light” and meanwhile display the control interface of LED Illumination on the touch screen of the electronic device supporting touch input. It works totally the same as if the user touches the LED icon displayed on the touch screen of the electronic device supporting touch input to “Turn on the LED Light”.

When the user conducts fingerprint input and, upon comparison and analysis, the system software confirms that the image block control code input sequence corresponding to the block control codes of those image blocks of the fingerprint images of the effective input is in the order from the block control code B22 to the block control code B12 and to the block control code C22, the system software will execute the application software executable program to “Open the Browser” and meanwhile display the control interface of Web Browser program on the touch screen of the electronic device supporting touch input. It works totally the same as if the user touches the Web Browser program icon displayed on the touch screen of the electronic device supporting touch input to “Open the Browser”. When the user conducts fingerprint input and, upon comparison and analysis, the system software confirms that the image block control code input sequence corresponding to the block control codes of those image blocks of the fingerprint images of the effective input is in the order from the block control code B22 to the block control code B23 and to the block control code C22, the system software will execute the application software executable program to “Open the Email” and meanwhile display the control interface of the Email program on the touch screen of the electronic device supporting touch input. It works totally the same as if the user touches the Email program icon displayed on the touch screen of the electronic device supporting touch input to “Open the Email”. When the user conducts fingerprint input and, upon comparison and analysis, the system software confirms that the image block control code input sequence corresponding to the block control codes of those image blocks of the fingerprint images of the effective input is in the order from the block control code B22 to the block control code B32 and to the block control code C22, the system software will execute the application software executable program to “Open LINE” and meanwhile display the control interface of the LINE program on the touch screen of the electronic device supporting touch input. It works totally the same as if the user touches the LINE program icon displayed on the touch screen of the electronic device supporting touch input to “Open LINE”. When the user conducts fingerprint input and, upon comparison and analysis, the system software confirms that the image block control code input sequence corresponding to the block control codes of those image blocks of the fingerprint images of the effective input is in the order from the block control code B22 to the block control code B21 and to the block control code C22, the system software will execute the application software executable program to “Open Facebook” and meanwhile display the control interface of the FACEBOOK program on the touch screen of the electronic device supporting touch input. It works totally the same as if the user touches the FACEBOOK program icon displayed on the touch screen of the electronic device supporting touch input to “Open Facebook”.

While the invention has been described in terms of preferred embodiments, those skilled in the art will recognize that the invention can be practiced with modifications within the spirit and scope of the appended claims.

What is claimed is:

1. A method for system control through fingerprint input, the method being applied in an electronic device supporting touch input, the method comprising the steps of:
performing fingerprint input recognition of fingerprints of three fingers of a user through a touch screen of the electronic device supporting touch input; and
creating and storing of the user's fingerprint recognition data;
wherein the fingerprint recognition data comprises a plurality of fingerprint images;
the built-in system software of the electronic device supporting touch input dividing the fingerprint image from the fingerprint recognition data into a plurality of image blocks and setting a corresponding block control code for each of the image blocks; through the input settings of the electronic device supporting touch input, the user can carry out the fingerprint image digital control setup program; the built-in system software of the electronic device supporting touch input can, according to the input settings of the user, set each individual block control code, or part of the block control codes or all of the block control codes to the command codes to execute the built-in digital executable programs of the system software; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding digital executable program to enter a number, a symbol, or a character; through the input settings of the electronic device supporting touch input, the user can carry out the fingerprint image touch control setup program; the built-in system software of the electronic device supporting touch input can, according to the input settings of the user, set each individual block control code, part of the block control codes, or all of the block control codes, respectively to the command codes to execute the touch control executable programs in the system software; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding touch control executable program to substitute for the gesture input where the user swipes on the screen or control the cursor position; through the input settings of the electronic device supporting touch input, the user can carry out the fingerprint image touch control setup program; the built-in system software of the electronic device supporting touch input can, according to the input settings of the user, set each individual block control code, part of the block control codes, or all of the block control codes, to the command codes to execute the system executable programs in the system software; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding system executable program to adjust the media volume or screen brightness, or to start, shut down, control or set the system functional operations of the electronic device supporting touch input; through the input settings of the electronic device supporting touch input, the user can carry out the fingerprint image game control setup program; the built-in system software of the electronic device supporting touch input can, according to the input settings of the user, set each individual block control code, part of the block control codes, or all of the block control codes, to the command codes to execute the game software executable programs in the system software; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding game software executable program for motion control of the character or hero in the game screen or to open the menu for selection, setting or control; through the input settings of the electronic device supporting touch input, the user can carry out the fingerprint image software control setup program; the built-in system software of the electronic device supporting touch input can, according to the input settings of the user, set each individual block control code, part of the block control codes, or all of the block control codes, to the command codes to execute the application software executable programs installed in the system software; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding application software executable program for selection, setting or control of the software functions; through the input settings of the electronic device supporting touch input, the user can carry out the fingerprint image sequence control setup program; and the built-in system software of the electronic device supporting touch input can, according to the input settings of the user, specify the input orders of specific permutations and combinations of each individual block control code, part of the block control codes, or all of the block control codes as input sequences of the image block control codes, and set the input sequences of the image block control codes to the command codes to execute the built-in digital executable programs of the system software, the command codes to execute the touch control executable programs, or the command codes to execute the system executable program, or the command codes to execute the game software executable programs in the system software, or the command codes to execute the application software executable programs.

2. A method for system control through fingerprint input, the method being applied in an electronic device supporting touch input, the method comprising the steps of:
performing fingerprint input recognition of fingerprints of three fingers of a user through a touch screen of the electronic device supporting touch input; and
creating and storing of the user's fingerprint recognition data;
wherein the fingerprint recognition data comprises first fingerprint image, second fingerprint image and third fingerprint image; the built-in system software of the electronic device supporting touch input can divide each fingerprint image from the fingerprint recognition data into 9 image blocks and set a corresponding block control code for each of the image blocks; wherein, in an order from top to bottom and from left to right, these image blocks are respectively defined as first image block, second image block, third image block, fourth image block, fifth image block, sixth image block, seventh image block, eighth image block, and ninth image block; the block control code of the first image block a1 of the first fingerprint image is set to A11, the block control code of the second image block a2 is set to A12, the block control code of the third image block a3 is set to A13, the block control code of the fourth image block a4 is set to A21, the block control code of the fifth image block a5 is set to A22, the block control code of the sixth image block a6 is set to A23, the block control code of the seventh image block a7 is set to A31, the block control code of the eighth image block a8 is set to A32, and the block control code of the ninth image block a9 is set to A33; the block control code of the first image block b1 of the second fingerprint image is set to B11, the block control code of the second image block b2 is set to B12, the block control code of the third image block b3 is set to B13, the block control code of the fourth image block b4 is set to B21, the block control code of the fifth image block b5 is set to B22, the block control code of the sixth image block b6 is set to B23, the block control code of the seventh image block b7 is set to B31, the block control code of the eighth image block b8 is set to B32, and the block control code of the ninth image block b9 is set to B33; the block control code of the first image block c1 of the third fingerprint image is set to C11, the block control code of the second image block c2 is set to C12, the block control code of the third image block c3 is set to C13, the block control code of the fourth image block c4 is set to C21, the block control code of the fifth image block c5 is set to C22, the block control code of the sixth image block c6 is set to C23, the block control code of the seventh image block c7 is set to C31, the block control code of the eighth image block c8 is set to C32, and the block control code of the ninth image block c9 is set to C33; through the input settings of the electronic device supporting touch input, the user can carry out the fingerprint image digital control setup program; the built-in system software of the electronic device supporting touch input can, according to the input settings of the user, set the block control codes of those image blocks of the first fingerprint image, the block control codes of those image blocks of the second fingerprint image, and the block control codes of those image blocks of the third fingerprint image, respectively to the command codes to execute the built-in digital executable programs of the system software; through the fingerprint image digital control setup program, the user can set the block control code A12 to the command code to execute the digital executable program to “Enter 0”, set the combination of the block control codes A21 and A31 to the command code to execute the digital executable program to “Enter 1”, set the combination of the block control codes A22 and A32 to the command code to execute the digital executable program to “Enter 2”, set the combination of the block control codes A23 and A33 to the command code to execute the digital executable program to “Enter 3”, set the block control code B12 to the command code to execute the digital executable program to “Enter 4”, set the combination of the block control codes B21 and B31 to the command code to execute the digital executable program to “Enter 5”, set the combination of the block control codes B22 and B32 to the command code to execute the digital executable program to “Enter 6”, set the combination of the block control codes B23 and B33 to the command code to execute the digital executable program to “Enter 7”, set the block control code C12 to the command code to execute the digital executable program to “Enter 8”, set the combination of the block control codes C21 and C31 to the command code to execute the digital executable program to “Enter 9”, set the combination of the block control codes C22 and C32 to the command code to execute the digital executable program to “Enter Symbol *”, set the combination of the block control codes C23 and C33 to the command code to execute the digital executable program to “Enter Symbol #”; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding digital executable program to enter a number, a symbol, or a character; when the user conducts fingerprint input and, upon comparison and analysis, the system software confirms that the block control code corresponding to the image block of the fingerprint image of the effective input is only A12, the system software will execute the digital executable program to “Enter 0” and meanwhile display Number 0 on the touch screen of the electronic device supporting touch input; it works totally the same as if the user touches Number 0 on the electronic numeric keyboard displayed on the touch screen of the electronic device supporting touch input to “Enter 0”; when the user conducts fingerprint input and, upon comparison and analysis, the system software confirms that the block control codes corresponding to those image blocks of the fingerprint image of the effective input are only the combination of A21 and A31, the system software will execute the digital executable program to “Enter 1” and meanwhile display Number 1 on the touch screen of the electronic device supporting touch input; it works totally the same as if the user touches Number 1 on the electronic numeric keyboard displayed on the touch screen of the electronic device supporting touch input to “Enter 1”; when the user conducts fingerprint input and, upon comparison and analysis, the system software confirms that the block control codes corresponding to those image blocks of the fingerprint image of the effective input are only the combination of A22 and A32, the system software will execute the digital executable program to “Enter 2” and meanwhile display Number 2 on the touch screen of the electronic device supporting touch input; it works totally the same as if the user touches Number 2 on the electronic numeric keyboard displayed on the touch screen of the electronic device supporting touch input to “Enter 2”; when the user conducts fingerprint input and, upon comparison and analysis, the system software confirms that the block control codes corresponding to those image blocks of the fingerprint image of the effective input are only the combination of A23 and A33, the system software will execute the digital executable program to “Enter 3” and meanwhile display Number 3 on the touch screen of the electronic device supporting touch input; it works totally the same as if the user touches Number 3 on the electronic numeric keyboard displayed on the touch screen of the electronic device supporting touch input to “Enter 3”; when the user conducts fingerprint input and, upon comparison and analysis, the system software confirms that the block control code corresponding to the image block of the fingerprint image of the effective input is only B12, the system software will execute the digital executable program to “Enter 4” and meanwhile display Number 4 on the touch screen of the electronic device supporting touch input; it works totally the same as if the user touches Number 4 on the electronic numeric keyboard displayed on the touch screen of the electronic device supporting touch input to “Enter 4”; when the user conducts fingerprint input and, upon comparison and analysis, the system software confirms that the block control codes corresponding to those image blocks of the fingerprint image of the effective input are only the combination of B21 and B31, the system software will execute the digital executable program to “Enter 5” and meanwhile display Number 5 on the touch screen of the electronic device supporting touch input; it works totally the same as if the user touches Number 5 on the electronic numeric keyboard displayed on the touch screen of the electronic device supporting touch input to “Enter 5”; when the user conducts fingerprint input and, upon comparison and analysis, the system software confirms that the block control codes corresponding to those image blocks of the fingerprint image of the effective input are only the combination of B22 and B32, the system software will execute the digital executable program to “Enter 6” and meanwhile display Number 6 on the touch screen of the electronic device supporting touch input; it works totally the same as if the user touches Number 6 on the electronic numeric keyboard displayed on the touch screen of the electronic device supporting touch input to “Enter 6”; when the user conducts fingerprint input and, upon comparison and analysis, the system software confirms that the block control codes corresponding to those image blocks of the fingerprint image of the effective input are only the combination of B23 and B33, the system software will execute the digital executable program to “Enter 7” and meanwhile display Number 7 on the touch screen of the electronic device supporting touch input; it works totally the same as if the user touches Number 7 on the electronic numeric keyboard displayed on the touch screen of the electronic device supporting touch input to “Enter 7”; when the user conducts fingerprint input and, upon comparison and analysis, the system software confirms that the block control code corresponding to the image block of the fingerprint image of the effective input is only C12, the system software will execute the digital executable program to “Enter 8” and meanwhile display Number 8 on the touch screen of the electronic device supporting touch input; it works totally the same as if the user touches Number 8 on the electronic numeric keyboard displayed on the touch screen of the electronic device supporting touch input to “Enter 8”; when the user conducts fingerprint input and, upon comparison and analysis, the system software confirms that the block control codes corresponding to those image blocks of the fingerprint image of the effective input are only the combination of C21 and C31, the system software will execute the digital executable program to “Enter 9” and meanwhile display Number 9 on the touch screen of the electronic device supporting touch input; it works totally the same as if the user touches Number 9 on the electronic numeric keyboard displayed on the touch screen of the electronic device supporting touch input to “Enter 9”; when the user conducts fingerprint input and, upon comparison and analysis, the system software confirms that the block control codes corresponding to those image blocks of the fingerprint image of the effective input are only the combination of C22 and C32, the system software will execute the digital executable program to “Enter Symbol *” and meanwhile display Symbol * on the touch screen of the electronic device supporting touch input; it works totally the same as if the user touches Symbol * on the electronic numeric keyboard displayed on the touch screen of the electronic device supporting touch input to “Enter Symbol *”; when the user conducts fingerprint input and, upon comparison and analysis, the system software confirms that the block control codes corresponding to those image blocks of the fingerprint image of the effective input are only the combination of C23 and C33, the system software will execute the digital executable program to “Enter Symbol #” and meanwhile display Symbol # on the touch screen of the electronic device supporting touch input; it works totally the same as if the user touches Symbol # on the electronic numeric keyboard displayed on the touch screen of the electronic device supporting touch input to “Enter Symbol #”; the method further comprising: executing a touch control setup program by the user through input settings of the electronic device supporting touch input; the built-in system software of the electronic device supporting touch input can, according to the input settings of the user, set the block control codes of those image blocks of the first fingerprint image and the block control codes of those image blocks of the second fingerprint image, respectively to the command codes to execute the touch control executable programs in the system software; through the fingerprint image touch control setup program, the user can set the block control code A12 to the command code to execute the touch control executable program to “Swipe Up”, set the block control codes of the combination of A21 and A31 to the command codes to execute the touch control executable program to “Swipe Left”, set the block control code A32 to the command code to execute the touch control executable program to “Swipe Down”, set the block control codes of the combination of A23 and A33 to the command codes to execute the touch control executable program to “Swipe Right”, set the block control code B12 to the command code to execute the touch control executable program to “Move Cursor Up”, set the block control codes of the combination of B21 and B31 to the command codes to execute the touch control executable program to “Move Cursor Left”, set the block control code B32 to the command code to execute the touch control executable program to “Move Cursor Down”, set the block control codes of the combination of B23 and B33 to the command codes to execute the touch control executable program to “Move Cursor Right”; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding touch control executable program to substitute for the gesture input where the user swipes on the screen or control the cursor position; when the user conducts fingerprint input and, upon comparison and analysis, the system software confirms that the block control code corresponding to the image block of the fingerprint image of the effective input is only A12, the system software will execute the touch control executable program to “Swipe Up”; it works totally the same as hand gesture input where the user touches and Swipes Up on the touch screen of the electronic device supporting touch input; when the user conducts fingerprint input and, upon comparison and analysis, the system software confirms that the block control codes corresponding to those image blocks of the fingerprint image of the effective input are only the combination of A21 and A31, the system software will execute the touch control executable program to “Swipe Left”; it works totally the same as hand gesture input where the user touches and Swipes Left on the touch screen of the electronic device supporting touch input; when the user conducts fingerprint input and, upon comparison and analysis, the system software confirms that the block control code corresponding to the image block of the fingerprint image of the effective input is only A32, the system software will execute the touch control executable program to “Swipe Down”; it works totally the same as hand gesture input where the user touches and Swipes Down on the touch screen of the electronic device supporting touch input; when the user conducts fingerprint input and, upon comparison and analysis, the system software confirms that the block control codes corresponding to those image blocks of the fingerprint image of the effective input are only the combination of A23 and A33, the system software will execute the touch control executable program to “Swipe Right”; it works totally the same as hand gesture input where the user touches and Swipes Right on the touch screen of the electronic device supporting touch input; when the user conducts fingerprint input and, upon comparison and analysis, the system software confirms that the block control code corresponding to the image block of the fingerprint image of the effective input is only B12, the system software will execute the touch control executable program to “Move Cursor Up”; it works totally the same as if the user touches the touch screen of the electronic device supporting touch input to Move Cursor Up and position the cursor; when the user conducts fingerprint input and, upon comparison and analysis, the system software confirms that the block control codes corresponding to those image blocks of the fingerprint image of the effective input are only the combination of B21 and B31, the system software will execute the touch control executable program to “Move Cursor Left”; it works totally the same as if the user touches the touch screen of the electronic device supporting touch input to Move Cursor Left and position the cursor; when the user conducts fingerprint input and, upon comparison and analysis, the system software confirms that the block control code corresponding to the image block of the fingerprint image of the effective input is only B32, the system software will execute the touch control executable program to “Move Cursor Down”; it works totally the same as if the user touches the touch screen of the electronic device supporting touch input to Move Cursor Down and position the cursor; when the user conducts fingerprint input and, upon comparison and analysis, the system software confirms that the block control codes corresponding to those image blocks of the fingerprint image of the effective input are only the combination of B23 and B33, the system software will execute the touch control executable program to “Move Cursor Right”; it works totally the same as if the user touches the touch screen of the electronic device supporting touch input to Move Cursor Right and position the cursor; the method further comprising: performing fingerprint image system control settings by the user through input settings of the electronic device supporting touch input; the built-in system software of the electronic device supporting touch input can, according to the input settings of the user, set the block control codes of those image blocks of the first fingerprint image and the block control codes of those image blocks of the second fingerprint image, respectively to the command codes to execute the system executable programs in the system software; through the fingerprint image system control setup program, the user can set the block control code A12 to the command code to execute the system executable program to “Increase the Media Volume”, set the block control code A32 to the command code to execute the system executable program to “Decrease the Media Volume”, set the block control codes of the combination of A23 and A33 to the command codes to execute the system executable program to “Increase the Screen Brightness”, set the block control codes of the combination of A21 and A31 to the command codes to execute the system executable program to “Decrease the Screen Brightness”, set the block control code B12 to the command code to execute the system executable program to “Enable the Camera Mode”, set the block control code B32 to the command code to execute the system executable program to “Enable the Dialing Mode”, set the block control codes of the combination of B23 and B33 to the command codes to execute the system executable program to “Enable the WIFI Mode”, set the block control codes of the combination of B21 and B31 to the command codes to execute the system executable program to “Turn on the LED Light”; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding system executable program to adjust the media volume or screen brightness, or to start, shut down, control or set the system functional operations of the electronic device supporting touch input; when the user conducts fingerprint input and, upon comparison and analysis, the system software confirms that the block control code corresponding to the image block of the fingerprint image of the effective input is only A12, the system software will execute the system executable program to “Increase the Media Volume”; it works totally the same as if the user touches the touch screen of the electronic device supporting touch input to increase the media volume; when the user conducts fingerprint input and, upon comparison and analysis, the system software confirms that the block control code corresponding to the image block of the fingerprint image of the effective input is only A32, the system software will execute the system executable program to “Decrease the Media Volume”; it works totally the same as if the user touches the touch screen of the electronic device supporting touch input to decrease the media volume; when the user conducts fingerprint input and, upon comparison and analysis, the system software confirms that the block control codes corresponding to those image blocks of the fingerprint image of the effective input are only the combination of A23 and A33, the system software will execute the system executable program to “Increase the Screen Brightness”; it works totally the same as if the user touches the touch screen of the electronic device supporting touch input to increase the screen brightness; when the user conducts fingerprint input and, upon comparison and analysis, the system software confirms that the block control codes corresponding to those image blocks of the fingerprint image of the effective input are only the combination of A21 and A31, the system software will execute the system executable program to “Decrease the Screen Brightness”, it works totally the same as if the user touches the touch screen of the electronic device supporting touch input to decrease the screen brightness; when the user conducts fingerprint input and, upon comparison and analysis, the system software confirms that the block control code corresponding to the image block of the fingerprint image of the effective input is only B12, the system software will execute the system executable program to “Enable the Camera Mode” and meanwhile display the control interface of Camera Mode on the touch screen of the electronic device supporting touch input; it works totally the same as if the user touches the Camera icon displayed on the touch screen of the electronic device supporting touch input to “Enable the Camera Mode”; when the user conducts fingerprint input and, upon comparison and analysis, the system software confirms that the block control code corresponding to the image block of the fingerprint image of the effective input is only B32, the system software will execute the system executable program to “Enable the Dialing Mode” and meanwhile display the control interface of Dialing Mode on the touch screen of the electronic device supporting touch input; it works totally the same as if the user touches the Dialing icon displayed on the touch screen of the electronic device supporting touch input to “Enable the Dialing Mode”; when the user conducts fingerprint input and, upon comparison and analysis, the system software confirms that the block control codes corresponding to those image blocks of the fingerprint image of the effective input are only the combination of B23 and B33, the system software will execute the system executable program to “Enable the WIFI Mode” and meanwhile display the control interface of WIFI Mode on the touch screen of the electronic device supporting touch input; it works totally the same as if the user touches the WIFI icon displayed on the touch screen of the electronic device supporting touch input to “Enable the WIFI Mode”; when the user conducts fingerprint input and, upon comparison and analysis, the system software confirms that the block control codes corresponding to those image blocks of the fingerprint image of the effective input are only the combination of B21 and B31, the system software will execute the system executable program to “Turn on the LED Light” and meanwhile display the control interface of LED Illumination on the touch screen of the electronic device supporting touch input; it works totally the same as if the user touches the LED icon displayed on the touch screen of the electronic device supporting touch input to “Turn on the LED Light”; the method further comprising: performing fingerprint image game control settings by the user through input settings of the electronic device supporting touch input; the built-in system software of the electronic device supporting touch input can, according to the input settings of the user, set the block control codes of those image blocks of the first fingerprint image, the block control codes of those image blocks of the second fingerprint image, and the block control codes of those image blocks of the third fingerprint image, respectively to the command codes to execute the game software executable programs in the system software; through the fingerprint image game control setup program, the user can set the block control code A12 to the command code to execute the game software executable program to “Move Forward”, set the block control codes of the combination of A21 and A31 to the command codes to execute the game software executable program to “Move Left”, set the block control code A32 to the command code to execute the game software executable program to “Move Backward”, set the block control codes of the combination of A23 and A33 to the command codes to execute the game software executable program to “Move Right”, set the block control code B12 to the command code to execute the game software executable program for “Attack Action”, set the block control codes of the combination of B21 and B31 to the command codes to execute the game software executable program for “Throwing Action”, set the block control code B32 to the command code to execute the game software executable program for “Jumping Action”, set the block control codes of the combination of B23 and B33 to the command codes to execute the game software executable program for “Defensive Action”, set the block control codes of the combination of C11 and C12 to the command codes to execute the game software executable program to “Open the Menu”, set the block control codes of the combination of C12 and C13 to the command codes to execute the game software executable program to “Turn off the Menu”, set the block control codes of the combination of C21 and C31 to the command codes to execute the game software executable program to “Select Left”, set the block control codes of the combination of C22 and C23 to the command codes to execute the game software executable program to “Select Right”, set the block control code C32 to the command code to execute the game software executable program to “Confirm”; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding game software executable program for motion control of the character or hero in the game screen or to open the menu for selection, setting or control; when the user conducts fingerprint input and, upon comparison and analysis, the system software confirms that the block control code corresponding to the image block of the fingerprint image of the effective input is only A12, the system software will execute the game software executable program to “Move Forward” so that the character or hero in the game screen of the touch screen of the electronic device supporting touch input will Move Forward; when the user conducts fingerprint input and, upon comparison and analysis, the system software confirms that the block control code corresponding to the image block of the fingerprint image of the effective input are only the combination of A21 and A31, the system software will execute the game software executable program to “Move Left”, so that the character or hero in the game screen of the touch screen of the electronic device supporting touch input will Move Left; when the user conducts fingerprint input and, upon comparison and analysis, the system software confirms that the block control code corresponding to the image block of the fingerprint image of the effective input is only A32, the system software will execute the game software executable program to “Move Backward”, so that the character or hero in the game screen of the touch screen of the electronic device supporting touch input will Move Backward; when the user conducts fingerprint input and, upon comparison and analysis, the system software confirms that the block control code corresponding to the image block of the fingerprint image of the effective input are only the combination of A23 and A33, the system software will execute the game software executable program to “Move Right”, so that the character or hero in the game screen of the touch screen of the electronic device supporting touch input will Move Right; when the user conducts fingerprint input and, upon comparison and analysis, the system software confirms that the block control code corresponding to the image block of the fingerprint image of the effective input is only B12, the system software will execute the game software executable program for “Attack Action”, so that the character or hero in the game screen of the touch screen of the electronic device supporting touch input will have the Attack Action; when the user conducts fingerprint input and, upon comparison and analysis, the system software confirms that the block control code corresponding to the image block of the fingerprint image of the effective input are only the combination of B21 and B31, the system software will execute the game software executable program for “Throwing Action”, so that the character or hero in the game screen of the touch screen of the electronic device supporting touch input will have the Throwing Action; when the user conducts fingerprint input and, upon comparison and analysis, the system software confirms that the block control code corresponding to the image block of the fingerprint image of the effective input is only B32, the system software will execute game software executable program for “Jumping Action”, so that the character or hero in the game screen of the touch screen of the electronic device supporting touch input will have the Jumping Action; when the user conducts fingerprint input and, upon comparison and analysis, the system software confirms that the block control code corresponding to the image block of the fingerprint image of the effective input are only the combination of B23 and B33, the system software will execute the game software executable program for “Defensive Action”, so that the character or hero in the game screen of the touch screen of the electronic device supporting touch input will have the Defensive Action; when the user conducts fingerprint input and, upon comparison and analysis, the system software confirms that the block control code corresponding to the image block of the fingerprint image of the effective input are only the combination of C11 and C12, the system software will execute the game software executable program to “Open the Menu”, so that the touch screen of the electronic device supporting touch input will display the game function menu screen; when the user conducts fingerprint input and, upon comparison and analysis, the system software confirms that the block control code corresponding to the image block of the fingerprint image of the effective input are only the combination of C12 and C13, the system software will execute the game software executable program to “Turn off the Menu”, so that the game function menu screen on the touch screen of the electronic device supporting touch input will be closed; when the user conducts fingerprint input and, upon comparison and analysis, the system software confirms that the block control code corresponding to the image block of the fingerprint image of the effective input are only the combination of C21 and C31, the system software will execute the game software executable program to “Select Left”, so that the selection cursor on the game function menu screen on the touch screen of the electronic device supporting touch input will Move Left; when the user conducts fingerprint input and, upon comparison and analysis, the system software confirms that the block control code corresponding to the image block of the fingerprint image of the effective input are only the combination of C23 and C33, the system software will execute the game software executable program to “Select Right”, so that the selection cursor on the game function menu screen on the touch screen of the electronic device supporting touch input will Move Right; when the user conducts fingerprint input and, upon comparison and analysis, the system software confirms that the block control code corresponding to the image block of the fingerprint image of the effective input is only C32, the system software will execute the game software executable program to “Confirm”, so that the selection cursor on the game function menu screen on the touch screen of the electronic device supporting touch input will Confirm the selection; the method further comprising: performing fingerprint image software control settings by the user through the input settings of the electronic device supporting touch input; the built-in system software of the electronic device supporting touch input can, according to the input settings of the user, set the block control codes of those image blocks of the first fingerprint image respectively to the command codes to execute the application software executable programs installed in the system software; through the fingerprint image software control setup program, the user can set the block control code A12 to the command code to execute the application software executable program to “Open the Browser”, set the block control code A32 to the command code to execute the application software executable program to “Open the Email”, set the block control codes of the combination of A23 and A33 to the command codes to execute the application software executable program to “Open LINE”, set the block control codes of the combination of A21 and A31 to the command codes to execute the application software executable program to “Open Facebook”; the user can conduct fingerprint input through the touch screen of the electronic device supporting touch input, and the system software will analyze the fingerprint input and compare it with the image blocks of those fingerprint images from the fingerprint recognition data stored in the system, so as to confirm the image blocks of the effective input of the user through fingerprint input; the system software will then obtain the block control code of the image block or the block control codes of those image blocks of the effective input to execute the corresponding application software executable program for selection, setting or control of the software functions; when the user conducts fingerprint input and, upon comparison and analysis, the system software confirms that the block control code corresponding to the image block of the fingerprint image of the effective input is only A12, the system software will execute the application software executable program to “Open the Browser” and meanwhile display the control interface of Web Browser program on the touch screen of the electronic device supporting touch input; it works totally the same as if the user touches the Web Browser program icon displayed on the touch screen of the electronic device supporting touch input to “Open the Browser”; when the user conducts fingerprint input and, upon comparison and analysis, the system software confirms that the block control code corresponding to the image block of the fingerprint image of the effective input is only A32, the system software will execute the application software executable program to “Open the Email” and meanwhile display the control interface of the Email program on the touch screen of the electronic device supporting touch input; it works totally the same as if the user touches the Email program icon displayed on the touch screen of the electronic device supporting touch input to “Open the Email”; when the user conducts fingerprint input and, upon comparison and analysis, the system software confirms that the block control codes corresponding to those image blocks of the fingerprint image of the effective input are only the combination of A23 and A33, the system software will execute the application software executable program to “Open LINE” and meanwhile display the control interface of the LINE program on the touch screen of the electronic device supporting touch input; it works totally the same as if the user touches the LINE program icon displayed on the touch screen of the electronic device supporting touch input to “Open LINE”; when the user conducts fingerprint input and, upon comparison and analysis, the system software confirms that the block control codes corresponding to those image blocks of the fingerprint image of the effective input are only the combination of A21 and A31, the system software will execute the application software executable program to “Open Facebook” and meanwhile display the control interface of the FACEBOOK program on the touch screen of the electronic device supporting touch input; it works totally the same as if the user touches the FACEBOOK program icon displayed on the touch screen of the electronic device supporting touch input to “Open Facebook”.

3. A method for system control through fingerprint input, comprising the steps of:
performing a fingerprint image sequence control setup program by a user through input settings of an electronic device supporting touch input;
wherein a built-in system software of the electronic device supporting touch input can, according to the input settings of the user, specifies the input orders of specific permutations and combinations of the block control codes of those image blocks of the first fingerprint image, the block control codes of those image blocks of the second fingerprint image, and the block control codes of those image blocks of the third fingerprint image as input sequences of the image block control codes, and set the input sequences of the image block control codes to the command codes to execute the built-in digital executable programs of the system software, the command codes to execute the touch control executable programs or the command codes to execute the system executable program, or the command codes to execute the game software executable programs in the system software or the command codes to execute the application software executable programs; through the fingerprint image sequence control setup program, the user can specify the input order from the block control code A22 to the block control code A12 and to the block control code C22 as an image block control code input sequence, and set it to the command code to execute the system executable program to “Enable the Camera Mode”, specify the input order from the block control code A22 to the block control code A23 and to the block control code C22 as an image block control code input sequence and set it to the command code to execute the system executable program to “Enable the Dialing Mode”, specify the input order from the block control code A22 to the block control code A32 and to the block control code C22 as an image block control code input sequence and set it to the command code to execute the system executable program to “Enable the WIFI Mode”, specify the input order from the block control code A22 to the block control code A21 and to the block control code C22 as an image block control code input sequence and set it to the command code to execute the system executable program to “Turn on the LED Light”, specify the input order from the block control code B22 to the block control code B12 and to the block control code C22 as an image block control code input sequence and set it to the command code to execute the application software executable program to “Open the Browser”, specify the input order from the block control code B22 to the block control code B23 and to the block control code C22 as an image block control code input sequence and set it to the command code to execute the application software executable program to “Open the Email”, specify the input order from the block control code B22 to the block control code B32 and to the block control code C22 as an image block control code input sequence and set it to the command code to execute the application software executable program to “Open LINE”, and specify the input order from the block control code B22 to the block control code B21 and to the block control code C22 as an image block control code input sequence and set it to the command code to execute the application software executable program to “Open Facebook”; when the user conducts fingerprint input and, upon comparison and analysis, the system software confirms that the image block control code input sequence corresponding to the block control codes of those image blocks of the fingerprint images of the effective input is in the order from the block control code A22 to the block control code A12 and to the block control code C22, the system software will execute the system executable program to “Enable the Camera Mode” and meanwhile display the control interface of Camera Mode on the touch screen of the electronic device supporting touch input; it works totally the same as if the user touches the Camera icon displayed on the touch screen of the electronic device supporting touch input to “Enable the Camera Mode”; when the user conducts fingerprint input and, upon comparison and analysis, the system software confirms that the image block control code input sequence corresponding to the block control codes of those image blocks of the fingerprint images of the effective input is in the order from the block control code A22 to the block control code A23 and to the block control code C22, the system software will execute the system executable program to “Enable the Dialing Mode” and meanwhile display the control interface of Dialing Mode on the touch screen of the electronic device supporting touch input; it works totally the same as if the user touches the Dialing icon displayed on the touch screen of the electronic device supporting touch input to “Enable the Dialing Mode”; when the user conducts fingerprint input and, upon comparison and analysis, the system software confirms that the image block control code input sequence corresponding to the block control codes of those image blocks of the fingerprint images of the effective input is in the order from the block control code A22 to the block control code A32 and to the block control code C22, the system software will execute the system executable program to “Enable the WIFI Mode” and meanwhile display the control interface of WIFI Mode on the touch screen of the electronic device supporting touch input; it works totally the same as if the user touches the WIFI icon displayed on the touch screen of the electronic device supporting touch input to “Enable the WIFI Mode”; when the user conducts fingerprint input and, upon comparison and analysis, the system software confirms that the image block control code input sequence corresponding to the block control codes of those image blocks of the fingerprint images of the effective input is in the order from the block control code A22 to the block control code A21 and to the block control code C22, the system software will execute the system executable program to “Turn on the LED Light” and meanwhile display the control interface of LED Illumination on the touch screen of the electronic device supporting touch input; it works totally the same as if the user touches the LED icon displayed on the touch screen of the electronic device supporting touch input to “Turn on the LED Light”; when the user conducts fingerprint input and, upon comparison and analysis, the system software confirms that the image block control code input sequence corresponding to the block control codes of those image blocks of the fingerprint images of the effective input is in the order from the block control code B22 to the block control code B12 and to the block control code C22, the system software will execute the application software executable program to “Open the Browser” and meanwhile display the control interface of Web Browser program on the touch screen of the electronic device supporting touch input; it works totally the same as if the user touches the Web Browser program icon displayed on the touch screen of the electronic device supporting touch input to “Open the Browser”; when the user conducts fingerprint input and, upon comparison and analysis, the system software confirms that the image block control code input sequence corresponding to the block control codes of those image blocks of the fingerprint images of the effective input is in the order from the block control code B22 to the block control code B23 and to the block control code C22, the system software will execute the application software executable program to “Open the Email” and meanwhile display the control interface of the Email program on the touch screen of the electronic device supporting touch input; it works totally the same as if the user touches the Email program icon displayed on the touch screen of the electronic device supporting touch input to “Open the Email”; when the user conducts fingerprint input and, upon comparison and analysis, the system software confirms that the image block control code input sequence corresponding to the block control codes of those image blocks of the fingerprint images of the effective input is in the order from the block control code B22 to the block control code B32 and to the block control code C22, the system software will execute the application software executable program to “Open LINE” and meanwhile display the control interface of the LINE program on the touch screen of the electronic device supporting touch input; it works totally the same as if the user touches the LINE program icon displayed on the touch screen of the electronic device supporting touch input to “Open LINE”; when the user conducts fingerprint input and, upon comparison and analysis, the system software confirms that the image block control code input sequence corresponding to the block control codes of those image blocks of the fingerprint images of the effective input is in the order from the block control code B22 to the block control code B21 and to the block control code C22, the system software will execute the application software executable program to “Open Facebook” and meanwhile display the control interface of the FACEBOOK program on the touch screen of the electronic device supporting touch input; it works totally the same as if the user touches the FACEBOOK program icon displayed on the touch screen of the electronic device supporting touch input to “Open Facebook”.
